(19) United States
(12) Patent Application Publication
(10) Pub. No.: US 2007/0212205 A1
(43) Pub. Date: Sep. 13, 2007

(54) Single pivot motion roll-off hoist

(76) Inventor: Jeffrey J. Lowecki, Spring Grove, IL (US)

Correspondence Address: MICHAEL P. MAZZA, LLC, 686 CRESCENT BLVD., GLEN ELYN, IL, 60137, US

(21) Appl. No.: 11/373,870

(22) Filed: Mar. 13, 2006

(51) Int. Cl. B60P 1/64

(52) U.S. Cl. 414/498; 414/546

(57) ABSTRACT

A truck-mounted, single pivot motion hoist assembly for the loading and unloading of containers. In a preferred embodiment, the hoist assembly includes a hoist frame rigidly mounted to the vehicle chassis. A lifting arm may be pivotally attached to the hoist frame, while hydraulic cylinders may be pivotally attached to the lifting arm. Spanning rear rollers may be used. In the preferred embodiment, the hoist assembly is capable of loading a wheel-less, rail-less container using a single pivot motion.

### BACKGROUND OF THE INVENTION

The present invention relates generally to hoist assemblies for roll-off containers. More specifically, the invention relates to such hoist assemblies enabling single pivot motion loading of mini roll-off containers.

The inventor is not aware of a single-pivot motion hook lift/roll off hoist that may be used with “rail-less,” “mini” containers as those terms are defined here, and/or that may be carried by vehicles as small as pick-up trucks, for example. The lack of such a device may, at least in part, be explained by design difficulties. For example, U.S. Pat. No. 5,427,495 to Vlaanderen (column 1:40-44) states: “Due to the geometric relationship between truck-mounted hydraulic loaders and the direct connection between the carriage and the truck, it is impossible to draw the carriage and the container fully over the truck frame.” The inventor believes he has solved this problem.

Accordingly, it would be desirable to provide a single-pivot motion hook lift used with railed or rail-less containers, including mini containers that may be carried on smaller vehicles such as pick-up trucks.

### SUMMARY OF THE INVENTION

The objects mentioned above, as well as other objects, are solved by the present invention, which overcomes disadvantages of prior hooklift light assemblies, while providing new advantages not previously obtainable with such assemblies.

In a particular preferred embodiment of the present invention, a hoist assembly is provided and mounted to a truck for loading and unloading containers. In one particular application, a mini-truck may be used to load/unload mini-containers. The hoist assembly includes a hoist frame rigidly mounted to a frame of the truck. A single pivot motion lifting arm is supported by and pivotally attached to the hoist frame, and used to lift the container from a ground-level resting position to a loaded position wherein the container rests on the truck bed. The lift arm is also used to unload the container from the loaded position to the ground-level resting position.

In the preferred embodiment, movement of the lifting arm may be powered by one or more hydraulic cylinders each having associated cylinder rods. As an example, each hydraulic cylinder may have a load capacity of about 30,000 pounds. The lifting arm may be pivotally attached to the hoist frame at one or more support plates. The cylinder rods may also be attached to a point(s) on the one or more support plates at a location sufficiently distanced from the pivotal attachment point on the support plate(s) of the lifting arm to the hoist frame, to enable the creation of sufficient torque to allow the lifting arm, given the cylinder(s) lifting capacity, to load and unload containers.

In a preferred embodiment, the hoist frame may include a box frame with a pair of side rails and a pair of cross bars. A supplemental cross support may be used to span the side rails. The hoist frame may also include front-secured corner cradles for aiding in the prevention of container sliding once the container is in the loaded position and the truck is moving. Rear supports positioned rearward of a rear bumper of the truck may also be used. The hoist frame may be attached to the vehicle frame using OEM mounting points.

Spanning rear rollers may be used to allow the hoist assembly to load and unload rail-less containers. The rear rollers may be positioned rearward of a rear bumper of the truck bumper, permitting the loading and unloading of wheel-less containers. The rear rollers may include side weldments to aid in the prevention of container sliding once the container is in the loaded position and the truck is moving.

The lifting arm may be generally L-shaped, and may be pivotally connected to the hoist frame at a fixed location located rearward of a rear axle of the truck.

In an alternative embodiment of the present invention, a method is provided for loading and unloading containers using a hoist assembly mounted to a truck having a truck bed and a forward cab. A provided hoist frame is rigidly mounted to a frame of the truck, and a provided single pivot motion lifting arm is supported by and pivotally attached to the hoist frame. The lifting arm is engaged to a container at a ground-level, resting position. The lifting arm is then rotated rearwardly in a single, continuous motion, thereby loading the container by moving it from the ground-level, resting position to a loaded position in which the container rests on the truck bed. To unload the container by moving it from the loaded position on the truck bed to the ground-level, resting position, the lifting arm is then rotated forwardly in a single, continuous motion. Movement of the lifting arm may be powered by one or more hydraulic cylinders each having associated cylinder rods. The cylinder rods may be attached to a support plate(s) at a point(s) distanced from the point(s) of pivotal attachment of the lifting arm to the hoist frame, thereby enabling the creation of sufficient torque to allow the lifting arm, given the cylinder(s) lifting capacity, to load and unload the containers.

### BRIEF DESCRIPTION OF THE DRAWINGS

The novel features which are characteristic of the invention are set forth in the appended claims. The invention itself, however, together with further objects and attendant advantages thereof, will be best understood by reference to the following description taken in connection with the accompanying drawings, in which:

FIG. 1 is a partial side view of a flat bed pick-up truck carrying a rail-less container using a preferred embodiment of the hook lift of the present invention;

FIG. 2 is a partial side view similar to FIG. 1 with the container in a slightly raised position;

FIG. 3 is a partial side view similar to FIG. 2 with the container in a more fully raised position;

FIG. 4 is a partial side view similar to FIG. 3 of the truck body with the hook lift fully extended, and the container at the ground level, rest position;

FIG. 5 is a partial side and rear perspective view of the truck body and hook lift of FIGS. 1-4;

FIG. 6 is a partial, enlarged perspective view of the rear of the container loaded on the rear of the truck carrying the hook lift apparatus of the present invention;

FIG. 7 is a partial, rear view of the apparatus and truck shown in FIG. 1;

FIG. 8 is a rear, perspective view of a canopied container suitable for use with a preferred embodiment of the hook lift apparatus of the present invention;

FIG. 9 is a perspective view of the present invention, showing a container-laden, roll-off hoist-bearing truck pulling a trailer with an additional container;

FIG. 10 is a top view of the truck body carrying the hook lift and hook lift support structure which forms a preferred embodiment of the present invention;

FIG. 11 is an enlarged partial perspective view of a portion of one of the main lifting cylinders and associated hydraulic lines and fittings;

FIG. 12 is a partial, enlarged view of the pivot portion of the hook lift embodiment of the present invention, only showing one main cylinder for convenience;

FIG. 13 is a partial, enlarged perspective view of the hook lift lifting cylinders and adjacent surroundings shown in FIG. 10;

FIG. 14 is a schematic diagram illustrating an electronic wiring layout for the electrical system of a preferred embodiment of the invention; and

FIG. 15 is preferred hydraulic circuit layout for the hydraulic system of a preferred embodiment of the invention.

### DEFINITION OF CLAIM TERMS

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

“Mini container” means a container which is less than or about five cubit yards in volumetric size.

“Rail-less container” means a container that does not possess main frame rails.

“Single pivot motion” refers to the loading movement of a container from a resting position on the ground to the loaded position in a truck, or to the unloading movement of a container from a loaded position in a truck to a resting position on the ground, using a lifting arm which rotates in a continuous motion about a single pivot connection to the truck frame.

“Spanning rear rollers” means rear rollers with guides -positioned outside of the container side rails.

“Mini-truck” means a vehicle such as a pick-up truck or other vehicle, having a payload of about ¾ tons or less.

“Wheel-less container” means a container that does not possess outboard wheels.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

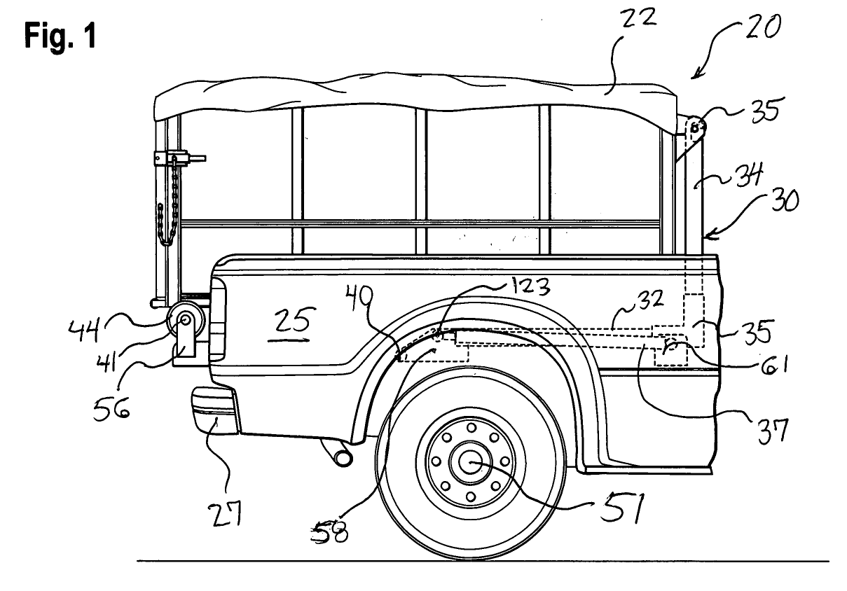

Referring now to FIG. 1, a preferred hook lift arm, generally designated by reference number 30, forming a preferred embodiment of the present invention is now described. Hook lift arm 30 together with a hoist frame 28, described below, is connected to and supported by truck vehicle frame 25. The hoist frame carries a mini container, designated generally as 20. Two additional OEM leaf springs, for example, may be added to the frame of the vehicle, such as but not limited to a pick-up truck, to allow the truck to more easily accommodate heavier payloads as may be encountered when lifting containers in the context of the present invention.

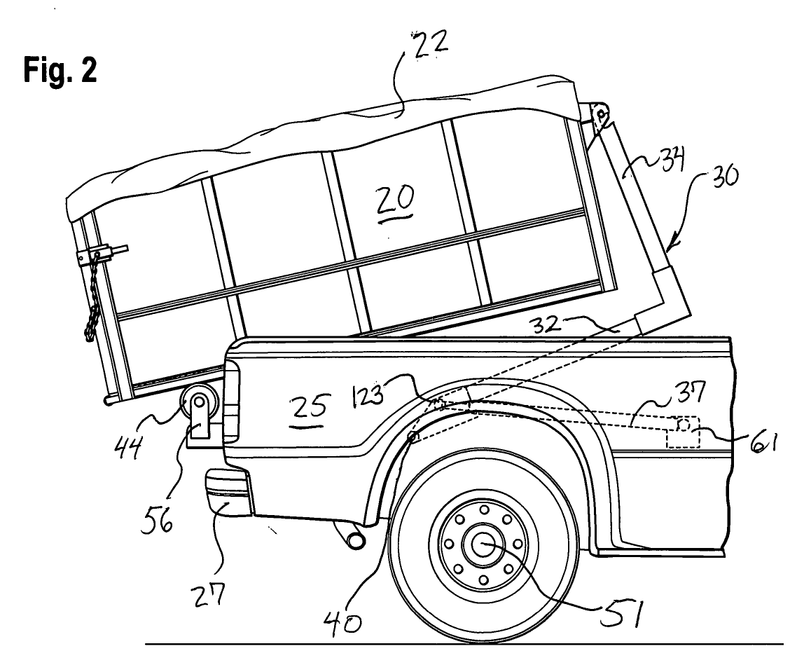

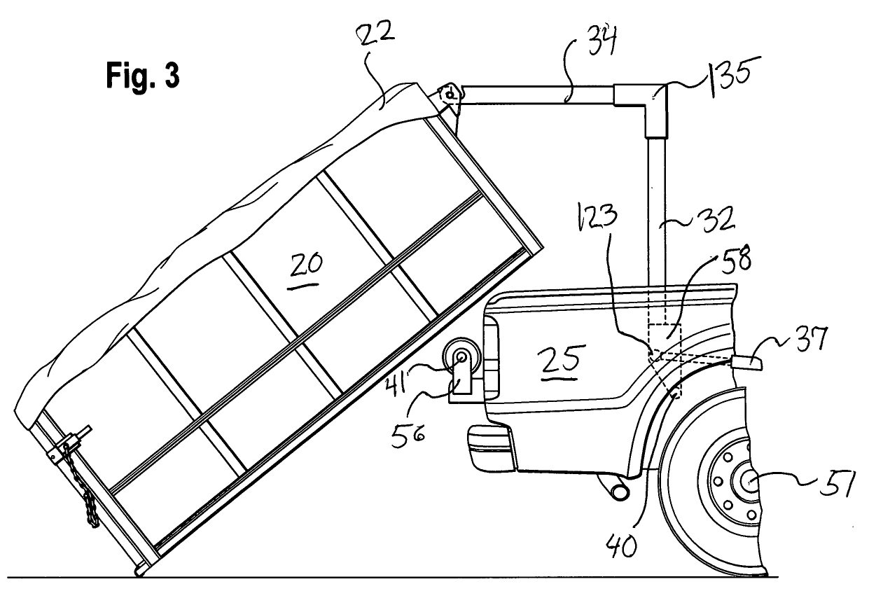

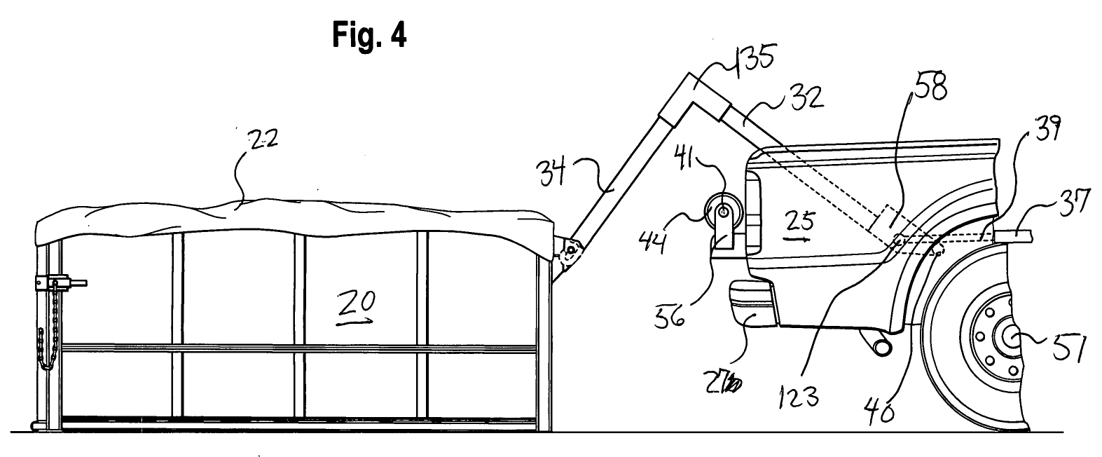

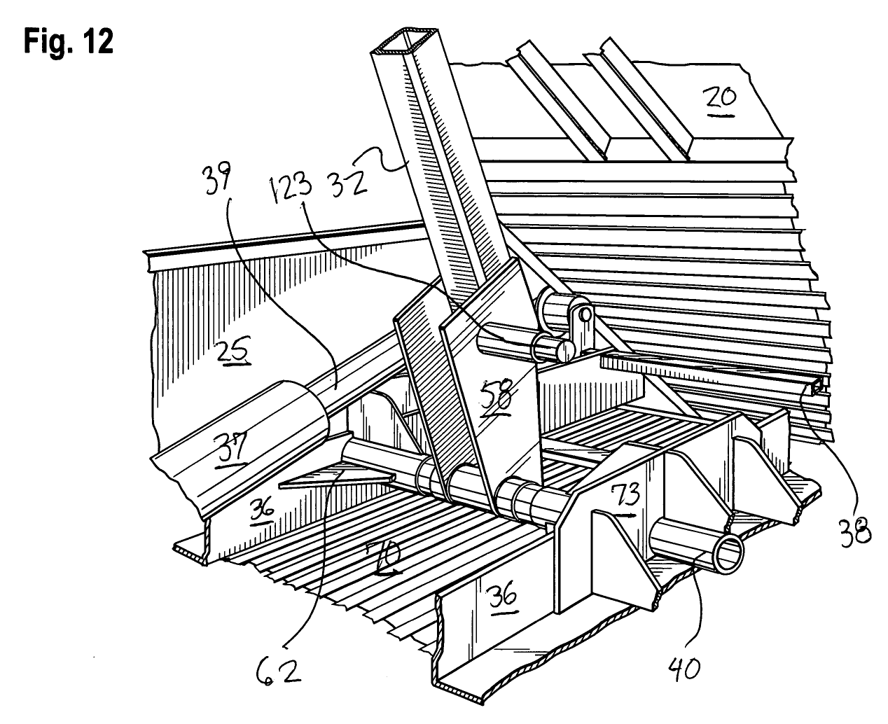

Referring to FIGS. 1-4, hook lift arm 30 includes a main pivot arm 32, a distal support arm 34, a support tube 135 at the arm 32/arm 34 rigid connection, and a hook 35 for attachment to container 20. Referring to FIG. 12, main pivot arm 32 may be rigidly attached to pivot plates 58, and also may be pivotally attached through the pivot plates to pivoting through-shaft 40, which is pivoted by the movement of attached cylinder rod 39 within main cylinder 37 (only one cylinder is shown in FIG. 12 for convenience, although two are present in the preferred embodiment shown in the drawings). Main cylinders 37 may be rigidly attached to the vehicle frame at attachment points 61 (see FIGS. 1, 2 and 10). Referring to FIGS. 1-4, 10 and 12, rotating rod 123 pivotally attaches cylinder rod 39s through plates 58 to main pivot arm 32. Arm 32 is welded to plates 58. Powering main cylinder 37 thus controls rotational movement of plates 58 about shaft 40 and, accordingly, of hook lift arm 30, allowing container 20 to be rolled off of the truck bed as shown in FIGS. 1-4, consecutively. In the preferred embodiment shown in the drawings: referring to FIGS. 1, 10 and 12, for example, the “x-coordinate” distance or length on plate 58 between main pivot point 40 and the attachment point of cylinder rods 39 to plate 58 (at rod 123) is about 12.5 inches, while the “y-coordinate” distance or height between those points is about 4 inches when the container is in a loaded, resting position on the truck bed, ready for truck transport; arm 32 may be about 45 and ¾ inches in length (from the cylinder rod pin to the end of bracket 135); and arm 34 may be about 40.5 inches in length (to about the bottom of the hook). (A 5 cubic-yard container, for example, is often about 9 feet in length.)

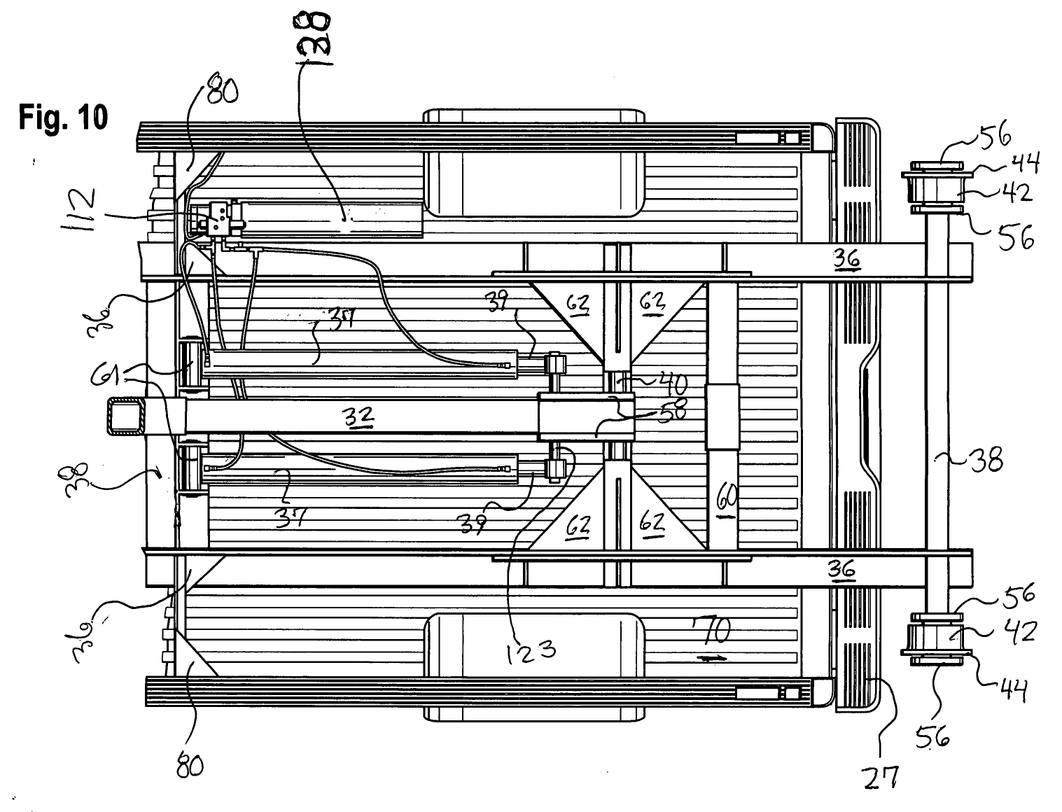

Referring to FIG. 10, a preferred embodiment of the hook lift support structure is shown. A suitably durable and sturdy rectangular “H-frame” or box style construction is formed by longitudinally extending side rails 36 and intersecting, supporting cross-bars 38 (e.g., 2.5-inch by 2.5-inch tubing, and ¼ inch thickness) and 60 (e.g., ¾ flat stock, 3-inches in width) (the “hoist frame 28”). Hoist frame 28 is rigidly connected to vehicle frame 25 as discussed below. Rotating through-shaft 40 (e.g., about 40 inches in length, with a 2-inch inside diameter, and a tube wall thickness of ½ inch), welded to the vehicle frame, may constitute the pivot location for lifting arm 30, preferably spans from one side of the main frame to the other, and may be supported using steel plates 73 (see FIG. 12) and (e.g., 9-inch by 9-inch triangular) angle gussets 62 (out of, e.g., ½-inch plate) (see FIG. 10), which contribute to the stability of through-shaft 40 as cylinder movement is translated into hook lift arm rotational movement during container loading/unloading. (To provide enhanced strength, a 2-inch solid, heat-treated pin, not shown in the drawings, is preferably located within shaft 40 and spans its length.) In this manner, the weight of the hoisted container is distributed out to the main frame, increasing vehicle stability during loading/unloading. In the preferred embodiment shown in the drawings, pivot 40 is located about 4 inches rearward of rear truck axle 51, while the center of pivot 40 is about 22 inches above the top of axle 51.

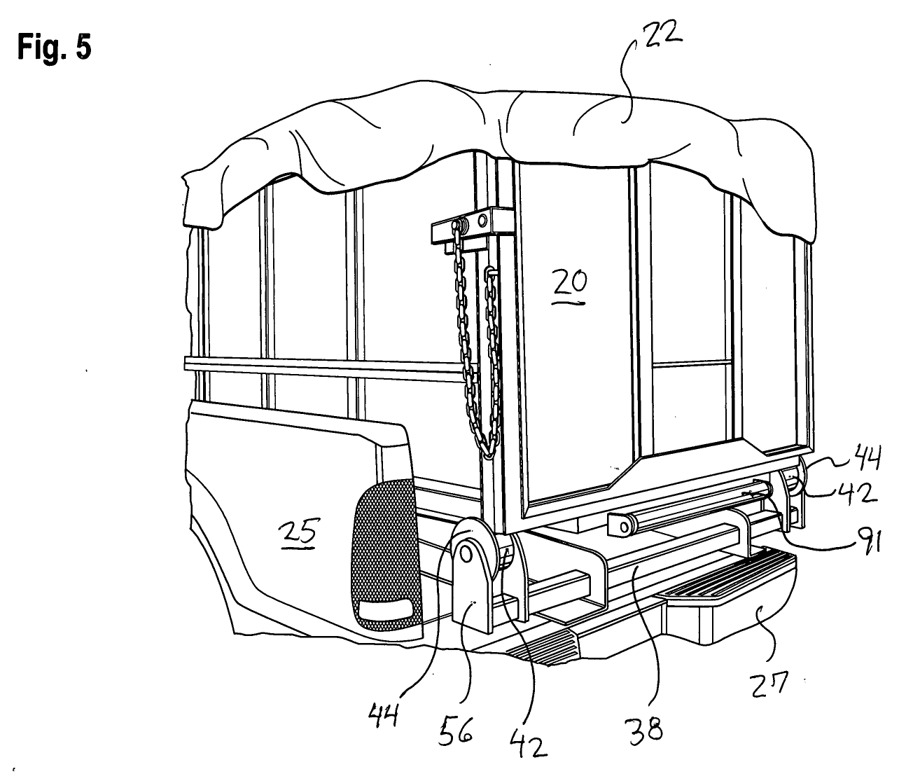

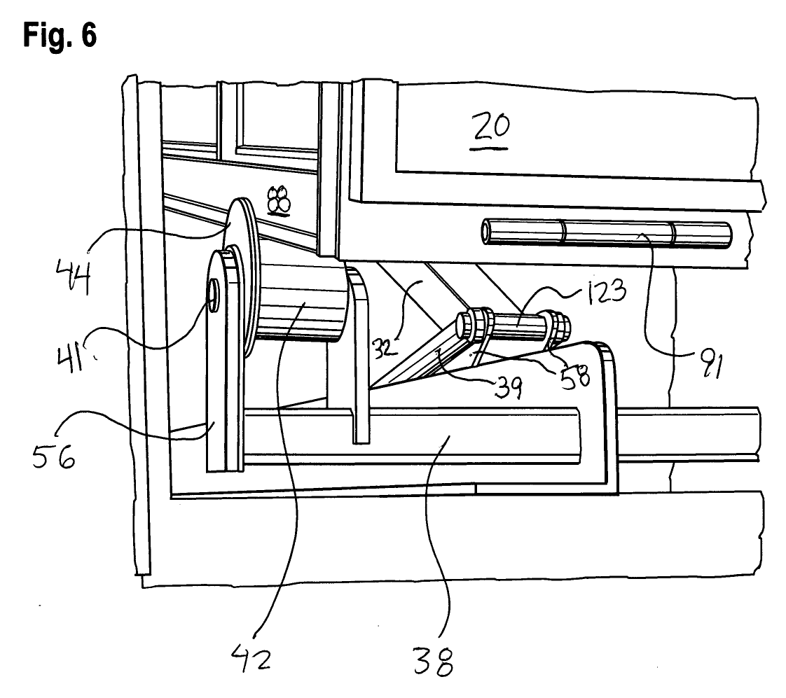

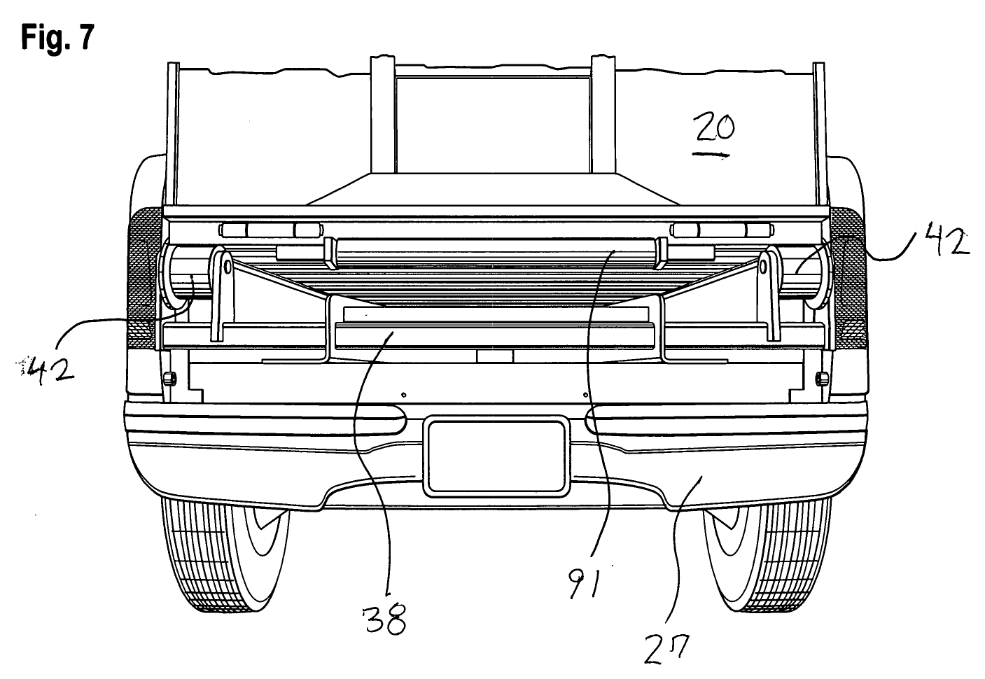

Container 20 is preferably cradled by the hoist frame to limit container movement during vehicle travel. In the preferred embodiment, cradling is accomplished using: (a) two front-secured corner cradles 80 (see FIG. 10) welded to hoist frame 28 for the container to rest in; these cradles preferably have upright bracing (not shown) to limit container sliding in front-to-back or side-to-side directions; and (b) rear rollers located at the rear of hoist frame 28, which the container rests on (see FIGS. 5-7), including side weldments 44 to prevent side-to-side container movement.

Loading/unloading of containers is achieving by rolling the container over rear rollers attached to hoist frame 28. Rear support bar 38, which is preferably located above and just rearward of truck bumper 27, includes rear rollers 42 to facilitate slidable loading and dumping of container 20 off of the truck. Side weldments 44 maintain the container over the rollers 42, as shown in FIGS. 5-7, and are retained in position by opposing end plates 56. To facilitate the ability of the container to roll on and off the vehicle in a stable manner, rollers 42 may consist of 4-inch diameter solid steel rollers with a 1-inch greaseable shaft 41. Rollers 42 are preferably positioned rear of bumper 27 a substantial distance from the pivot location at shaft 40 so that rotational movement of hook lift arm 30 will cause container 20 to unload from the truck. By positioning the rear rollers rearward of the truck bumper, loading/unloading may be achieved without the use of any additional outrigger wheels attached to the container. Rear support bar 38 may constitute a 2-inch by ¼-inch rear square tube elevated to support the rear rollers, and joining the main frame (rails 36) from side-to-side. The use of this heavy square tube 38 provides the ability to span the rear rollers outward. With spanning rear rollers, containers used with the hook lift of the present invention do not need main frame rails. Instead, the containers may be of a simple box construction, allowing container sides 88 to roll over rear rollers 42 during loading/unloading.

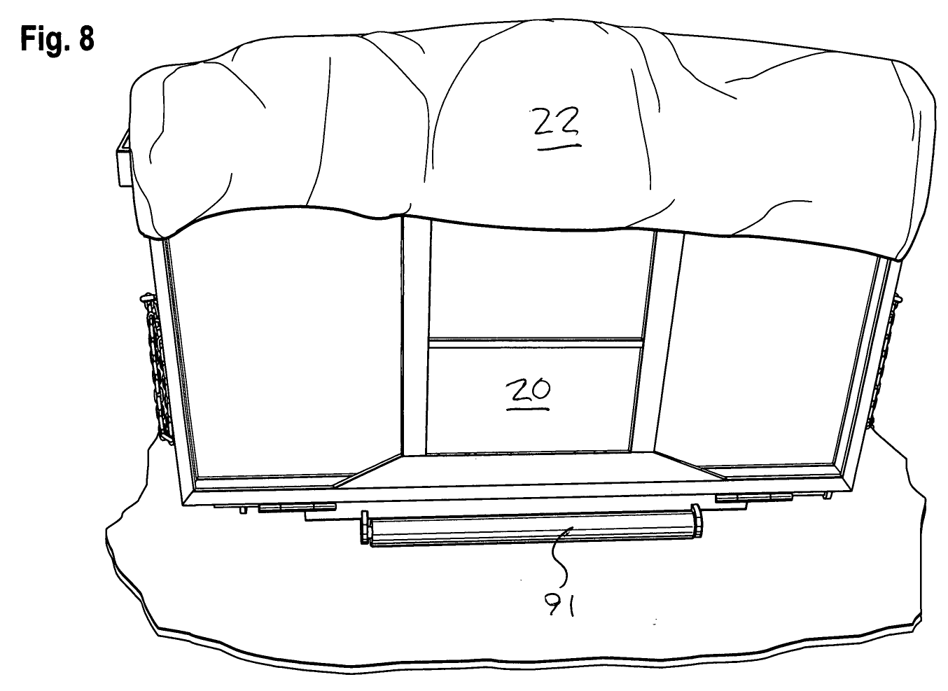

Referring to FIGS. 5-8, in one embodiment of container 20, a single lengthy rear roller 91 is provided, which has proven to facilitate loading and unloading of container 20 from the truck using the hooklift of the present invention.

Several benefits of the present invention should now be apparent to those of ordinary skill in the art. A design as shown in the drawings allows for hoist frame 28 (rails 36 and support bars 38, 60) to straddle directly over the vehicle frame rails below truck bed 70. In other words, the push/pull forces encountered while loading or unloading a container occur directly over the vehicle's main frame, enhancing truck stability during loading and unloading.

Another benefit of the design of the present invention is that the main frame preferably utilizes the same original equipment manufacturer (“OEM”) mounting points (e.g., 8 bolts) used to attach the (e.g.) flat bed to vehicle frame 25, to attach hoist frame 28 to the vehicle frame. This distributes the loading/unloading forces based on combinations of the (e.g.) eight mounting points at the various loading/unloading degrees encountered by the container, providing a highly stable base for loading/unloading.

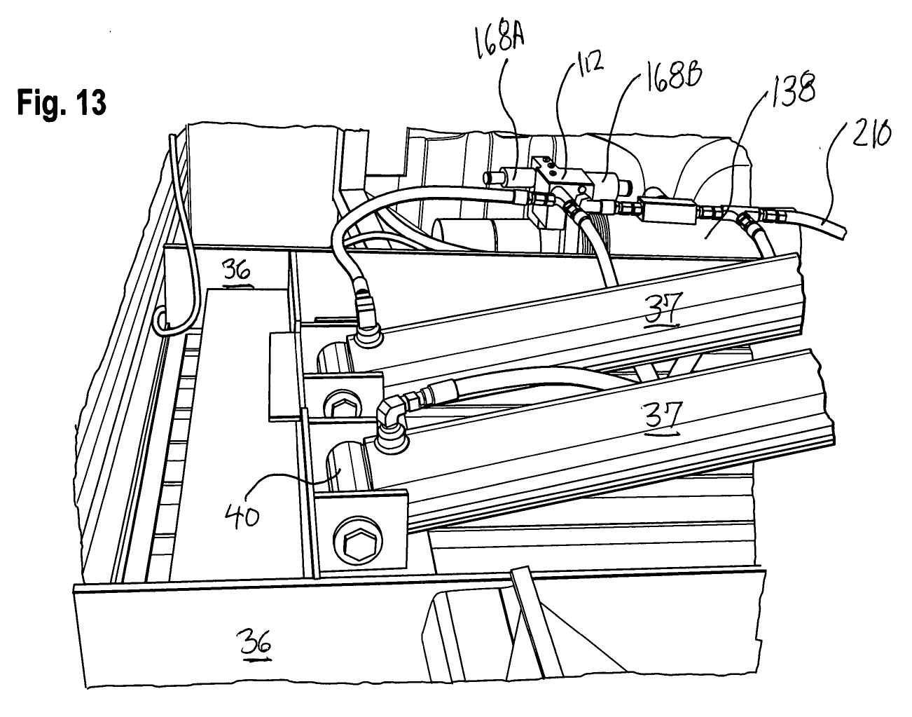

Referring to FIGS. 10 and 13-15, the hook lift of the present invention may be conveniently powered by the vehicle's battery, such as 12-volt truck battery 102. Hydraulic motor 104, such as a 12 volt DC motor (1-terminal standard duty) and pump 106, such as an AFC 2.0 CC, reversible pump with a 2-gallon reservoir capacity, for example, may be used. The lifting capacity of main cylinders 37 may vary given the application but preferably exceeds 30,000 pounds/cylinder.

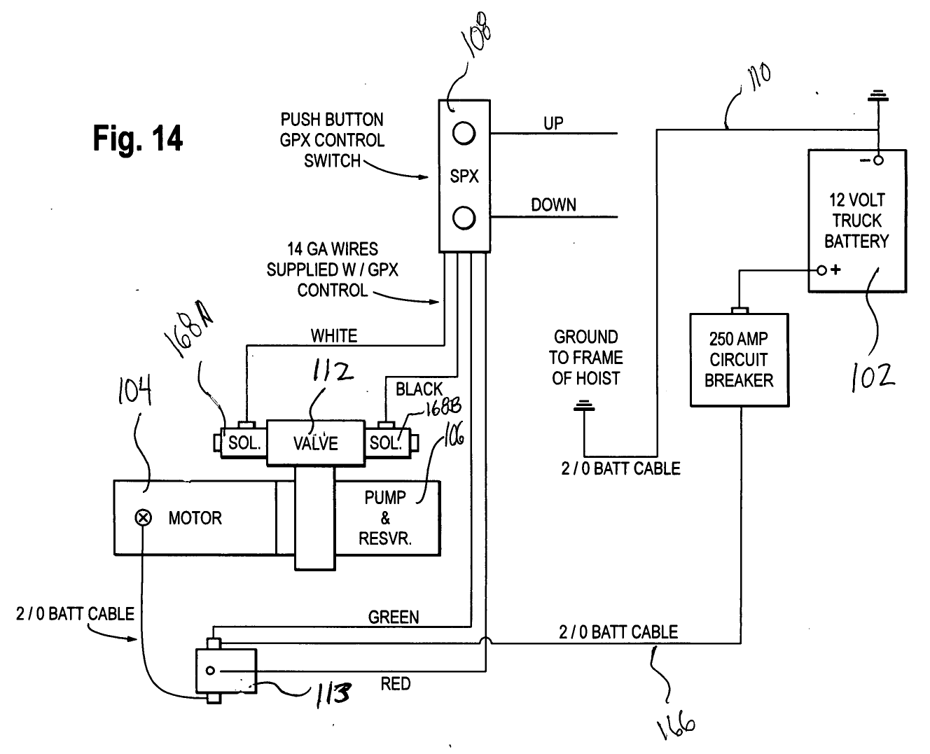

Referring to FIG. 14, a preferred electrical system for use with the hook-lift of the present invention will now be described. In the preferred embodiment, a 12-volt negative ground system may be provided. A positive cable hot-feed may be provided from the positive side of the battery 102 of the vehicle carrying the hoist. A cable 166 may be used to connect the positive side of the battery 102 to a 250 amp circuit breaker. A cable may also be used to connect the circuit breaker to a 12 volt solenoid 168 mounted on an electrical drive motor 104 for a hydraulic pump 106. The 12-volt solenoid 168 may be used to control the flow of power using (e.g.) a two push-button, hand-held controller 108. A ground cable 110 may be employed to connect the negative side of the vehicle battery 102 to the structural steel frame of the hoist, with a negative cable connecting the hoist to the flame of the vehicle. The electric hydraulic motor 104 may also be controlled via a 12-volt, two-push-button, hand-held switch controller. Switch controller 108 receives 12 volts of current from the 12-volt solenoid 168 mounted on the 12-volt electrical drive motor 104 for the hydraulic pump 108. The switch controller may be provided with two push buttons for controlling two 12-volt electrical solenoids 168 mounted on the body of hydraulic valve 112 by pushing one of the two-push button switches on the hand-held controller; this opens the circuit on 12-volt solenoid 113 and one of the two solenoids on the hydraulic valve body, allowing 12 volts of current to flow to the 12-volt electrical motor which drives the hydraulic pump. The two valve body, 12-volt solenoids may be mounted on the hydraulic valve body. Each of the two solenoids may be used to control the directional flow of hydraulic fluids being pumped from the electric/hydraulic pump.

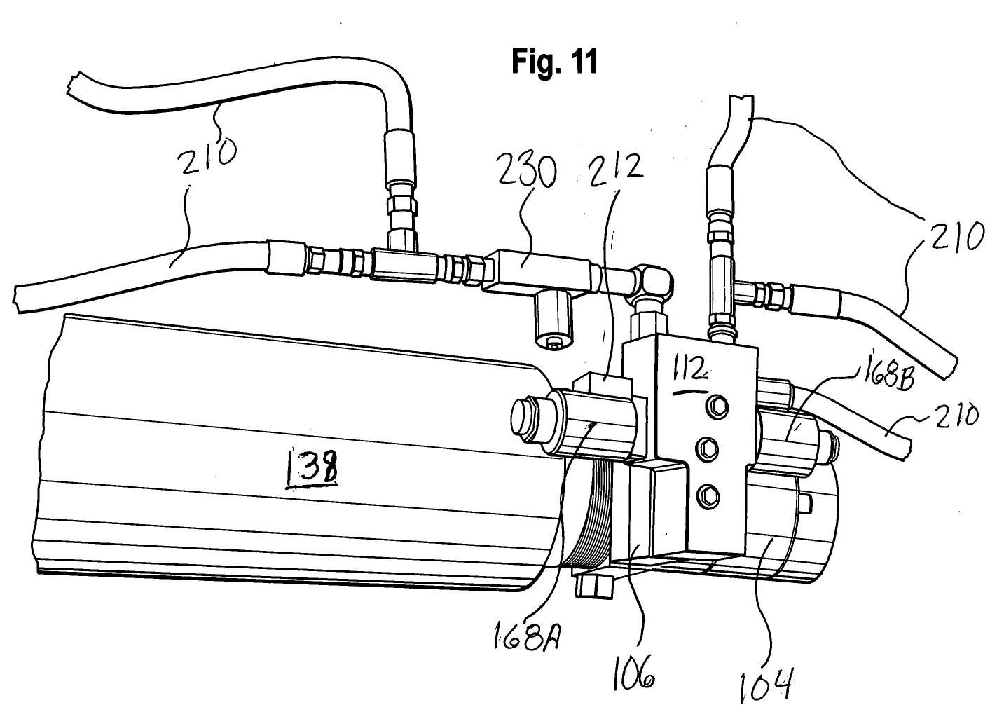

Referring to FIGS. 10-15, a preferred hydraulic system for use with the hook-lift of the present invention will now be described. In the preferred embodiment, a 12-volt electric hydraulic pump 106 with an incorporated hydraulic valve body 112 may be employed. One preferred pump has a two-gallon hydraulic fluid reservoir, for use with two 4-inch diameter cylinders having a 30-inch stroke/ travel, and an overall extended length of about 66 inches; preferred hydraulic cylinders 37 have a 2-inch rod diameter and operate at 2500 PSI. Hydraulic fluid from reservoir 138 may be pumped from the electric/hydraulic pump 106 at 2500 PSI. The directional flow of hydraulic fluid may be controlled by two electric solenoids 168A, 168B mounted to the hydraulic valve body. The directional flow of the hydraulic fluid may be controlled via motor 104 and hydraulic pump 106 such that hydraulic fluid may be caused to flow through hydraulic hoses 210 to one of two ports located on each of the hydraulic cylinders. A restrictor valve 212 (FIG. 11) may be used as an adjustable valve to control the amount of hydraulic fluid going to and from the hydraulic cylinders, as needed given cylinder function.

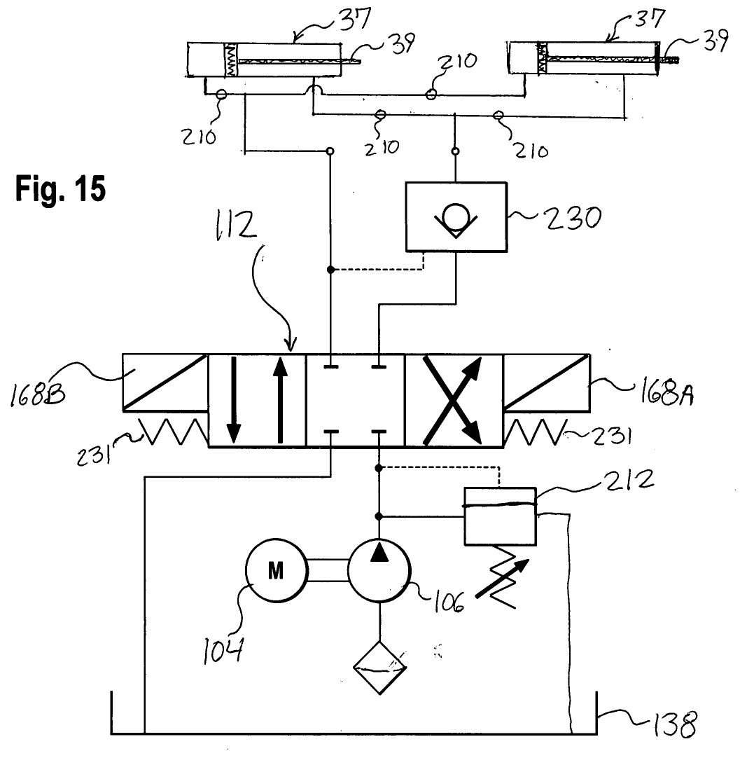

Referring to FIG. 15, hydraulic valve 112 is a 4-way, 3-position control valve. In this schematic representation, hydraulic valve 112 is shown in its normally closed center position. When valve 112 is in the neutral center position, all ports are blocked and hydraulic fluid cannot flow through the valve body. When power is applied to electrical solenoid actuator 168B, hydraulic valve 112 shifts from the center neutral position to the left position. This allows fluid to flow from hydraulic pump 106, through check valve 230, and into the rod ends of the two double-acting hydraulic cylinders 37 to force piston rods 39 to retract. At the same time, the opposite “blind” ends of hydraulic cylinders 37 are allowed to freely drain through hydraulic valve 112 into hydraulic reservoir 138. When power is removed from solenoid actuator 168B, spring 231 moves the hydraulic valve 112 back to the neutral center position. In this position, flow is stopped to and from the two hydraulic cylinders 37 and piston rods 39 stop moving and hold in place. Similarly, when power is applied to solenoid actuator 168A, the hydraulic valve 112 shifts from the center neutral position to the right position. This allows fluid to flow from hydraulic pump 106 into the blind ends of both double-acting hydraulic cylinders 37 to force piston rods 39 to extend. At the same time, the rod ends of the two hydraulic cylinders 37 are allowed to freely drain through check valve 230 and hydraulic valve 112 into hydraulic reservoir 138. When power is removed from solenoid actuator 168A, spring 231 once again moves hydraulic valve 112 back to the neutral center position. In this position, flow is again stopped to and from the hydraulic cylinders 37 and the piston rods stop moving and hold in place. When the hydraulic valve 112 is in the neutral position and pump 106 is being driven by electric motor 104, the hydraulic fluid has nowhere to flow upon exiting pump 106. Since hydraulic fluid is virtually non-compressible, pump 106 will stall, and damage to the pump 106 and electric motor 104 can result. To prevent this damage, the hydraulic system may incorporate an adjustable pressure relief valve 212. When hydraulic valve 112 is in the neutral position, the pressure build up in the line downstream of pump 106 will cause pressure relief valve 212 to open, draining the hydraulic fluid into hydraulic reservoir 138. When hydraulic valve 112 is actuated by electrical solenoids 168A or 168B, relief valve 212 closes and hydraulic fluid passes to hydraulic cylinders 37. A pilot-to-open check valve 230 may be placed in the line connecting to the rod ends of each double acting hydraulic cylinder 37 as a safety precaution to prevent container 20 from falling, should electric motor 104, pump 106, or a hydraulic line 210 fail while the piston rods in cylinder 37 are being extended. Should a hydraulic failure of this type occur, pilot-to-open check valve 230 may be used to sense a loss in pressure in the lines leading to the blind ends of the hydraulic cylinders 37 and slam shut, preventing fluid from draining to hydraulic reservoir 138 through valve 112, thus preventing further extension of the piston rods.

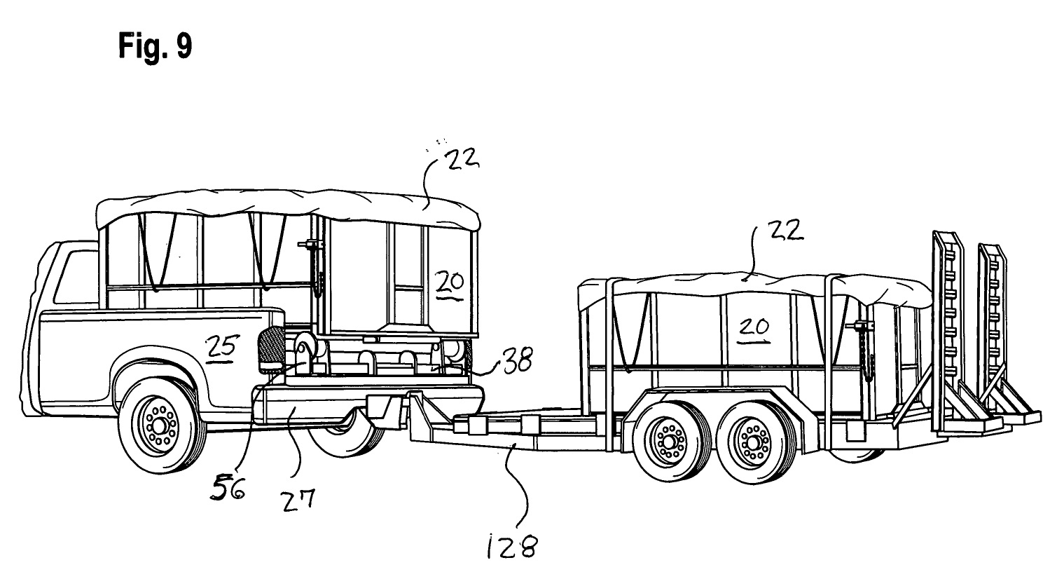

FIG. 9 illustrates an alternative embodiment of the present invention, employing two mini-hook lift containers, one carried by a pick-up truck, and another carried by a trailer 128 pulled by the truck.

It should now be apparent to those of ordinary skill in the art that the hook lift of the present invention may be used for a variety of purposes, including for garbage/recycling, waste disposal, tree/leave disposal, landscaping purposes, etc.

The above description is not intended to limit the meaning of the words used in the following claims that define the invention. For example, persons of ordinary skill in the art will understand that a variety of other designs still falling within the scope of the following claims may be envisioned and used. It is contemplated that these or other future modifications in structure, function or result will exist that are not substantial changes and that all such insubstantial changes in what is claimed are intended to be covered by the claims.

I claim:

1. A hoist assembly mounted to a truck for loading and unloading containers, comprising:
a hoist frame rigidly mounted to a frame of the truck having a truck bed; and
a single pivot motion lifting arm supported by and pivotally attached to the hoist frame for lifting the container from a ground-level resting position to a loaded position wherein the container rests on the truck bed, and for unloading the container from the loaded position to the ground-level resting position.

2. The hoist assembly of claim 1, wherein the movement of the lifting arm is powered by one or more hydraulic cylinders each having associated cylinder rods, and wherein each of the one or more cylinder rods is attached at a location distanced from the pivotal attachment of the lifting arm to the hoist frame.

3. The hoist assembly of claim 2, further comprising one or more support plates rigidly attached to the lifting arm, wherein at a first pivot attachment point the one or more support plates are pivotally attached to the hoist frame, and at a second pivot attachment point the one or more support plates are pivotally attached to the one or more cylinder rods, and wherein the first and second pivot attachment points are sufficiently distant from each other to enable the creation of sufficient torque to allow the lifting arm to load and unload the container.

4. The hoist assembly of claim 1, wherein the hoist frame comprises a box frame including pair of side rails and a pair of cross bars.

5. The hoist assembly of claim 1, wherein the lifting arm is generally L-shaped.

6. The hoist assembly of claim 1, further comprising spanning rear rollers allowing the hoist assembly to load and unload rail-less containers.

7. The hoist assembly of claim 6, wherein the rear rollers are positioned rearward of a rear bumper of the truck bumper, permitting the loading and unloading of wheel-less containers.

8. The hoist assembly of claim 1, wherein the lifting arm is pivotally connected to the hoist frame at a fixed location located rearward of a rear axle of the truck.

9. The hoist assembly of claim 1, wherein the hoist frame further comprises front-secured corner cradles for aiding in the prevention of container sliding once the container is in the loaded position and the truck is moving.

10. The hoist assembly of claim 7, further comprising rear supports positioned rearward of a rear bumper of the truck.

11. The hoist assembly of claim 6, wherein the rear rollers include side weldments to aid in the prevention of container sliding once the container is in the loaded position and the truck is moving.

12. The hoist assembly of claim 1, wherein the hoist frame is attached to the vehicle frame using OEM mounting points.

13. The hoist assembly of claim 4, further comprising a supplemental cross support spanning the side rails.

14. The hoist assembly of claim 2, wherein the one or more hydraulic cylinders each have a load capacity of at least about 30,000 pounds.

15. A hoist assembly mounted to a mini-truck having a truck bed, for loading and unloading mini-containers, comprising:
a hoist frame rigidly mounted to a frame of the truck; and
a single pivot motion lifting arm supported by and pivotally attached to the hoist frame for lifting the container from a ground-level resting position to a loaded position wherein the container rests on the truck bed, and for unloading the container from the loaded position to the ground-level resting position.

16. The hoist assembly of claim 15, wherein the mini-container is rail-less and wheel-less.

17. A method for loading and unloading containers using a hoist assembly mounted to a truck having a truck bed and a forward cab, comprising:
providing a hoist frame rigidly mounted to a frame of the truck;
providing a single pivot motion lifting arm supported by and pivotally attached to the hoist frame;
engaging the lifting arm to the container at a ground-level, resting position;
rotating the lifting arm rearwardly in a single, continuous motion and thereby loading the container by moving it from the ground-level, resting position to a loaded position in which the container rests on the truck bed; and
rotating the lifting arm forwardly in a single, continuous motion and thereby unloading the container by moving it from the loaded position on the truck bed to the ground-level resting position.

18. The method of claim 17, wherein the lifting arm is powered for rotation by one or more hydraulic cylinders each having associated cylinder rods, wherein the hoist frame includes one or more support plates, wherein each of the one or more cylinder rods is attached to the one or more support plates at a rod attachment point, and wherein the pivotal attachment of the lifting arm to the hoist frame is located on the one or more support plates at a lifting arm attachment point, and wherein the rod and lifting arm attachment points are sufficiently distanced to enable the creation of sufficient torque to allow the lifting arm to load and unload the container.
